(19) United States
(12) Patent Application Publication
(10) Pub. No.: US 2010/0255251 A1
(43) Pub. Date: Oct. 7, 2010

(54) PANEL WITH HIGH STRUCTURAL STRENGTH, DEVICE AND METHOD OF MAKING SUCH A PANEL

(76) Inventor: Guy Le Roy, Paris (FR)

Correspondence Address: GREER, BURNS & CRAIN, 300 S WACKER DR, 25TH FLOOR, CHICAGO, IL, 60606, US

(21) Appl. No.: 12/727,042

(22) Filed: Mar. 18, 2010

Related U.S. Application Data
(63) Continuation-in-part of application No. PCT/FR2008/051670, filed on Sep. 18, 2008.

(30) Foreign Application Priority Data
Sep. 18, 2007 (FR) 07 57658

(51) Int. Cl. B32B 7/00; D04H 18/00

(52) U.S. Cl. 428/119; 28/107; 428/98

(57) ABSTRACT

A composite panel includes two fibrous skins, and a core placed in an inner volume between the skins and linked to the skins by a solidified bonding material, in which linking fibers originating from at least one of the skins have been rammed into the inner volume between the skins, wherein at least part of the rammed fibers have at least one oblique orientation in relation to at least one of the skins.

The present application is a Continuation-In-Part of, and claims priority under 35 USC §120 from PCT/FR2008/051670 filed Sep. 18, 2008, which claims priority from French Patent Application No. 07 57658 filed Sep. 18, 2007.

### BACKGROUND

This invention relates to a composite panel.

This invention also relates to a device for making such a panel.

This invention also relates to a method of producing the is composite panel.

So-called “sandwich” composite panels are well known and include two skins that are resistant to various stresses, placed on each side of a core which is typically made from foam or felt. The skins comprise a fibrous reinforcement impregnated with a resin that confers on these skins a certain intrinsic rigidity as well as a bond with the core.

These panels are very widespread in applications in which walls must be produced that are rigid, light, durable, impact resistant, etc.

A particular function of the core is to keep a substantially fixed distance between the two skins. Consequently, the panel can only flex to the extent that the radially outer (relative to the bending axis) skin is capable of stretching, and the radially inner skin is capable of contracting. As the skins have a low ability to stretch and contract, the panel is stiff in bending.

However, the known panels are subject to the risk of so-called “delamination” consisting in that, in particular under bending stress, at least one of the skins becomes detached from the core. In this case, the mechanical characteristics of the panel deteriorate unacceptably.

In order to overcome this difficulty, the creation of a mechanical bond between each skin and the core has been proposed. For example the production of a seam between the fibrous reinforcement of the skin and the core has been proposed, before the step of impregnation of the skins with the resin. Such methods are effective to some extent, but they require additional steps with complex machines that are relatively slow and considerably increase the investment in industrial plant and the time required for making a panel. Panels reinforced in this way are therefore expensive.

Known document EP 1 686 210 A1 describes composite panels in which a powdery or fibrous core is stabilized between two skins by a step of needlepunching through, such needlepunching making fibers from the skins penetrate into the material of the core, perpendicularly to the plane of the core. However, these structures can deteriorate is when subjected to certain stresses.

### SUMMARY

The purpose of the present invention is thus to propose a composite panel offering improved mechanical characteristics, as well as a device and a method for making such a panel.

This purpose is achieved with a composite panel, comprising two fibrous skins, and a core placed in an inner volume between the skins and linked to the skins by a solidified bonding material, in which linking fibers originating from at least one of the skins have been rammed into the inner volume between the skins, wherein at least a portion of the rammed fibers have at least one oblique orientation in relation to at least one of the skins.

The rammed fibers behave so as to root each skin in the core. This rooting effectively opposes the delamination of the panel.

In this document, an orientation is termed oblique in relation to a skin if this orientation is oblique in relation to the surface of the skin, that is to say, slanting in relation to the skin surface, i.e. not perpendicular to the skin surface. According to the invention, the at least one oblique orientation considerably reinforces the mechanical strength of the panel according to the invention in comparison with the panels of the prior art.

The core can comprise at least one element having a pre-established shape defining at least one geometrically defined supporting face for at least one of the skins.

Preferably, the rammed fibers have at least two different orientations. The two orientations can comprise an orientation substantially perpendicular to at least one of the skins. The two orientations are preferably inclined in opposite directions to each other in relation to the skins. In this document, two orientations are termed inclined in opposite directions to each other in relation to a skin if they is are inclined in opposite directions in relation to a surface normal of the skin. In an embodiment, rammed fibers following a first orientation are substantially parallel to a first plane of orientation, rammed fibers following a second orientation (different from the first) are substantially parallel to a second plane of orientation, the first plane of orientation and the second plane of orientation being transverse (preferably substantially perpendicular) to each other, the fibers according to the first orientation and the fibers according to the second orientation all being substantially parallel to a plane of alignment transverse to the planes of orientation, this plane of alignment preferably being substantially perpendicular to the surface of at least one of the skins. Similarly, in a embodiment, rammed fibers following a first orientation are substantially parallel to a first plane of alignment substantially perpendicular to the surface of at least one of the skins, rammed fibers following a second orientation (different from the first) are substantially parallel to a second plane of alignment substantially perpendicular to the surface of this same at least one of the skins, the first plane and the second plane of alignment being transverse (preferably substantially perpendicular) to each other.

Preferably, the rammed fibers are grouped in tufts situated at sites where bonding material is also present. In this case, the rammed fibers have at least two different orientations. Tufts of rammed fibers following a first orientation are preferably each secant or tangent to a tuft of rammed fibers following a second orientation. This allows for bonding, by the bonding material, between tufts of the first and second orientation at the level of at least one junction point between tufts, which considerably improves the structural strength of the panel according to the invention in comparison with the panels of the prior art.

The bonding material can be a resin, a binder, a foamed resin, etc. with which the panel is impregnated after the process of ramming is the fibers, or also a material obtained by modification of the fibers, for example a component of the fibers that melts when the fibers are exposed to heat. The bonding material ensures consolidation of the skins and stratification of the panel.

Preferably, the rammed fibers are located along geometrical patterns such as rows, squares and staggered points. The nature of these patterns, as well as the dimension of the elementary pattern, allows for certain areas of the panel, and/or the whole of the panel, to be more or less reinforced.

The core is typically, but not limitatively, made from foam. Although this material is preferable in most applications, it is in no way obligatory according to the invention. Virtually any material allows for the application of the invention. The core can for example include at least one material from foam, rigid materials, fluid or semi-fluid materials such as powdery materials, powder emulsions, thermoplastic, thermofusible or thermoset materials. It can moreover be envisaged that the core comprises intercalaries, inserts, tubes or also rigid reinforcements.

By the term “skin”, is meant preferably a layer having a relatively small thickness dimension in relation to two other straight or curved dimensions defining a surface such as a length and a width. Thus, a skin can generally be substantially considered as a surface. A skin comprises at least one fiber batt. The fiber batt can be embedded within a bonding material such as for example a resin. At least one of the skins can be multi-layer. A skin can for example be constituted by a textile intended to provide the rammed fibers and at least a part of the mechanical strength of the skin in tension, and a layer of another type, having for example at least one insulating, waterproofing, burglar-proof, aesthetic, additional mechanical strength, fireproofing, and/or etc. functions. Said other layer can be placed on the core side or the opposite side, in relation to the fibrous reinforcement. The use of skins of different types and/or weights within the same composite panel can is be envisaged.

It is also possible to produce a panel comprising at least two superimposed cores optionally with an inner skin, in particular a fibrous skin, inserted between the two cores. In this case the bonding fibers can be rammed until they become joined to this inner skin thus forming a bridge between the outer skin and the inner skin.

The fibers of the skins of a panel according to the invention can be of all types. Preferably, for fiber batts, preference will be given to available non-woven fibrous materials, whether of an organic or mineral type, such as: metal, animal, vegetable, plastic, textile, carbon fibers etc.

According to another aspect of the invention, a device is proposed for making a panel according to the invention, characterized by comprising:
insertion means for inserting a core between two fibrous skins in a needlepunching path along a travel direction, the core (3) comprising preferably at least one preformed element
at least one needlepunching unit comprising needles and arranged in order to ram the fibers of at least one of the skins into a volume situated between the skins, preferably at a workstation on which the skins are supported by the at least one preformed element of the core, the at least one needlepunching unit comprising means of actuating its needles obliquely according to an inclination of strike in relation to a travel plane of the core and skins.

According to the invention, the means of obliquely actuating the needles allow fibers originating from at least one of the skins to be rammed obliquely into the core. This in turn allows to considerably increase the mechanical strength of the completed panel and promotes the drainage and dispersion of bonding material where there are sites or tufts of rammed fibers.

The at least one needlepunching unit can comprise means of is adjusting the inclination of strike along which its needles are actuated, in relation to said travel plane.

The device according to the invention can comprise two needlepunching units arranged on either side of the travel plane. The two units can be adjustable in inclination of strike independently of each other. The two units can be controlled from the same shaft, the device comprising means of adjusting a setting of the strike cycles of the two units in relation to each other, in particular as a function of their respective inclination of strike. The two needlepunching units can be arranged in order to orient a penetration of their needles into the core partially along the travel direction of the core and skins, or partially along a direction opposite to the travel direction of the core and skins. Finally, a first one of these needlepunching units can be arranged in order to ram tufts of fibers following a first orientation, and a second of these needlepunching units can be arranged in order to ram tufts of fibers following a second orientation, such that the tufts following the first orientation are each secant or tangent to at least one tuft of rammed fibers following the second orientation.

The tips of the needles of the at least one needlepunching unit are preferably in a plane substantially parallel to the travel plane.

The needles can be of equal length and each has a shank supported against a rear face of a needle board, this rear face being generally substantially parallel to the travel plane. Preferably, the rear face of the needle board includes openings for the support and positioning of the needle shanks. The device according to the invention can comprise moreover means of changing the rear face of the at least one needlepunching unit. This can make it possible in particular to adapt the needlepunching unit to different inclinations of strike, such that, for these different inclinations, the rear face of the unit is always substantially parallel to the travel plane, i.e. the tips of the needles of the unit are contained in a plane that is always substantially parallel to the travel plane.

The at least one needlepunching unit can have a bevel along an edge transverse to the travel plane and facing the travel plane.

The activation means can comprise at least one belt passing around a pulley held by a shaft arranged transversally in relation to the travel direction of the core and skins, the at least one needlepunching unit comprising at least one mobile element, holding the needles, fixed to one side of the belt, and the inclination of strike can be adjustable by pivoting of the needlepunching unit about the axis of the shaft. Moreover, the activation means can comprise a second belt passing around a second pulley held by the same shaft and coupled to a mobile element of a second needlepunching unit acting on the other side of the travel plane. The shaft can be situated on one side of the travel plane, the mobile element situated on the same side of the plane as the shaft being preferably essentially situated outside the loop formed by the corresponding belt, and the other mobile element being preferably essentially situated inside the loop formed by the corresponding belt.

According to a further aspect of the invention, a method is proposed for producing a composite panel according to the invention, wherein tufts of fibers of at least one of the skins are obliquely rammed by needlepunching into the inner volume where the core is situated. By ramming the tufts of fibers obliquely, the mechanical strength of the panel made using the method according to the invention is considerably increased and the drainage and dispersion of bonding material is facilitated at the tufts of rammed fibers.

The tufts of fibers can be rammed following at least two different orientations, in particular by carrying out two needlepunching passes separated by a pivoting of the panel (preferably through substantially 90 degrees) in its own plane, fibers rammed following a first orientation being substantially parallel to a first plane of alignment substantially perpendicular to the surface of at least one of the skins, fibers rammed following a second orientation (different from the first) being substantially parallel to a second plane of alignment substantially is perpendicular to the surface of this same at least one of the skins, the first plane of alignment and the second plane of alignment being transverse (preferably substantially perpendicular) to each other.

Finally, the method according to the invention can comprise ramming tufts of fibers following a first orientation, and ramming of tufts of fibers following a second orientation, such that the tufts following the first orientation are each secant or tangent to at least one tuft of rammed fibers following the second orientation. These different rammings can be carried out in one pass in a manufacturing device according to the invention comprising at least two needlepunching units, or by carrying out, in a manufacturing device according to the invention comprising at least one needlepunching unit, at least two needlepunching passes separated by a pivoting of the panel in its own plane.

When a relatively hard material constitutes the core, provision can be made for recesses to be formed in advance in this material in sites provided for ramming the fibers.

It is possible to ram the fibers over only a portion of the thickness of the inner volume. This is advantageous for very thick panels.

Preferably, the rammed fibers form bridges linking the two skins together. To this end, it can be arranged for the fibers of one skin to reach and be implanted in the fibrous reinforcement of the other skin in order to produce a bond between the two skins by needlepunching.

Fibers are known having two components comprising a periphery that is sensitive to an outside influence, for example thermofusible, and a central core resistant to said influence. In this case the periphery of the fiber acts according to the invention is a bonding material.

But in most cases, according to the invention, the bonding material is an impregnation material added at a stage subsequent to the ramming of the fibers, such as resin. Preferably, according to the invention, the fibers are then inserted into recesses formed in the core is in such a way as to promote the subsequent inflow of the resin, during the impregnation.

Other features and advantages of the invention will also become apparent from the description below, which relates to non-limitative examples.

### BRIEF DESCRIPTION OF THE DRAWINGS

In the attached drawings:

FIG. 1 is a perspective view, with cutaway, of a preferred embodiment of the panel according to the invention;

FIG. 2 is a perspective view of the fibrous structure of the panel in FIG. 1;

FIG. 3 shows in cross section, on a larger scale, a detail of the panel in FIG. 1, at a site for ramming the fibers;

FIGS. 4 and 5 are partial longitudinal cross-sectional views of a preferred embodiment of the manufacturing device according to the invention, representing a needlepunching apparatus equipped with two needlepunching units, the needlepunching apparatus being respectively in the retracted position and in the maximum penetration position;

FIG. 6 is an enlargement of a part of FIGS. 4 and 5, showing a cross-sectional view of the needle attachment device;

FIG. 7 is a cross-sectional part-view of the distribution of individual tufts in the core obtained according to the arrangement of the needlepunching units shown in FIGS. 4 and 5;

FIGS. 8 and 10 are longitudinal cross-sectional part-views of the device in FIGS. 4 and 5, showing the needlepunching apparatus in FIGS. 4 and 5 and a control device;

FIG. 9 is a longitudinal cross-sectional part-view of the distribution of the individual tufts in the core obtained according to the arrangement of the needlepunching units shown in FIG. 8;

FIG. 11 is a longitudinal cross-sectional part-view of the distribution of the individual tufts in the core obtained according to the arrangement of the needlepunching units shown in FIG. 10;

FIG. 12 is a cross-sectional side view of the control device in FIGS. 8 and 10;

FIGS. 13 and 14 are longitudinal cross-sectional part-views of the device in FIGS. 4, 5, 8 and 10, showing the needlepunching apparatus and the insertion means;

FIG. 15 is a top end part-view of the left end in FIG. 13;

FIG. 16 is an overall view of the manufacturing device according to the invention, in diagrammatic side elevation;

FIG. 17 is a view similar to FIG. 13 but relating to an improved version;

FIG. 18 is a top part-view of a guide comb of the device in FIG. 17;

FIG. 19 is a longitudinal cross-sectional view of a first embodiment of a machine according to the invention for producing a panel with tufts along more than one plane of alignment;

FIG. 20 is a top view of a major portion of the machine of FIG. 19;

FIG. 21 is a diagrammatic perspective view of a panel with tufts exhibiting three planes of alignment;

FIG. 22 is a plan view of the panel of FIG. 21;

FIG. 23 is a plan view of another embodiment of a panel with three planes of alignment; and

FIGS. 24 and 25 are plan views of two embodiments of a panel with four planes of alignment.

### DETAILED DESCRIPTION

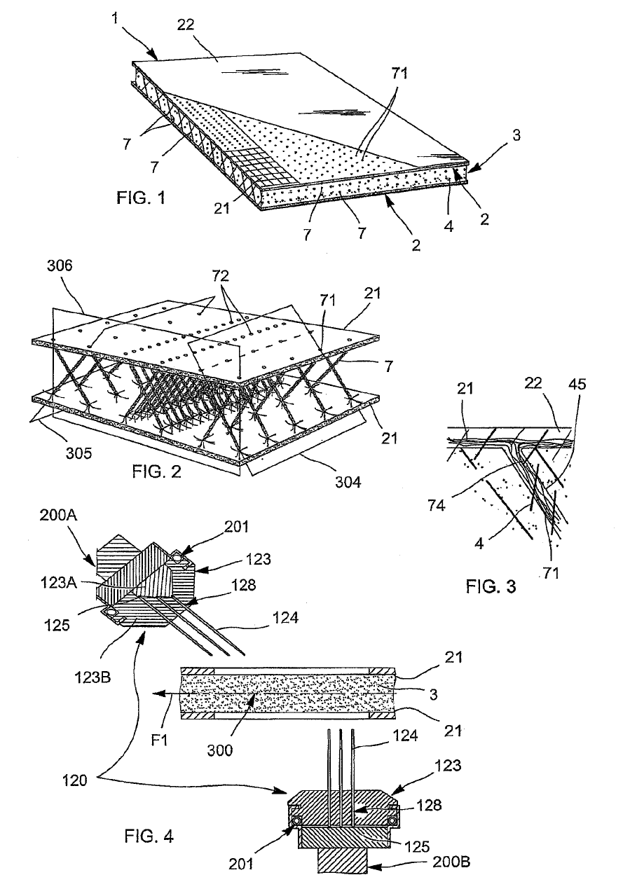

With reference to FIGS. 1, 2 and 3, an embodiment of panel 1 according to the invention will now be described. By the term “panel” is meant according to the invention a composite material having a relatively small thickness dimension in relation to two other straight or curved dimensions such as a length and a width. In particular, the term “panel” does not limit the object in question to a solid object, nor to an object having a constant thickness.

The composite panel 1 comprises two skins 2 extending in parallel planes and between them defining an inner volume occupied by a core 3. In the example shown, the core 3 is constituted by a foam slab 4.

Each skin 2 consists of a fiber batt 21 which is embedded within a bonding material such as a resin 22. In FIG. 1, the resin 22 is diagrammatically shown superimposed on the fiber batt 21. In practice, as shown in FIG. 3, the resin 22 impregnates the fibers 21, thus producing a solidification of the fiber-resin assembly as well as firmly attaching this assembly to the surface of the core 3. Depending on the nature of the foam, which can for example have open pores or closed pores, and the nature of the bonding material 22, the latter can impregnate, or not, the regions of the foam 4 that adjoin the skins 2. FIG. 3 shows a degree of impregnation of these adjoining regions.

According to the invention, the composite panel 1 comprises fibers 7 originating from one and/or the other of the batts 21, which during production of the panel have been rammed into the core 3. At least part of the fibers is rammed following at least one orientation that is oblique in relation to the plane of the skins 2, into the inner volume occupied by the core 3 between the skins.

The rammed fibers 7 are grouped into individual tufts 71 arranged according to a pattern of longitudinal columns and transverse rows, having in the particular example in FIG. 1 a staggered arrangement in a portion of the slab 4, and a more tightly spaced arrangement with square elementary patterns along one of the sides of the slab. Generally, it is provided for the rammed fibers to be distributed according to a pattern and a density chosen at will in each area of the panel. The creation of differentiated transverse or longitudinal areas can even be envisaged, for example by adopting a suitable distribution of the needles or by modulating the speed of feeding a panel through the manufacturing device that will be described below.

The rammed fibers 7 in the example in FIG. 1 extend from one to the other of the two skins 2, forming bridges of fibers between the two skins at each site of implantation of the tufts 71. FIG. 2, which shows the fibrous structure of the panel 1, shows that each bridge creates a fibrous bond between the two fiber batts 21. In the example in FIG. 2, the pattern of implantation of the individual tufts 71 is square and not staggered.

The rammed fibers 7 of the panel 1 are all contained within a set of mutually parallel planes and are oriented obliquely in relation to the surface of the skins 2, following two orientations inclined in opposite directions to each other, such that the tufts 71 are secant or at least tangent at least two by two.

Tufts of rammed fibers following a first orientation are substantially parallel to a first plane of orientation 304, tufts of rammed fibers following a second orientation are substantially parallel to a second plane of orientation 305. The first plane of orientation and the second plane of orientation are substantially perpendicular to each other. The fibers following the first orientation and the fibers following the second orientation are all substantially parallel to a plane of alignment 306 transverse to the planes of orientation 304, 305 and substantially perpendicular to the skins 21. By this means of X-shaped assembly of the tufts of the composite panel, the stresses induced in the finished product are distributed and transmitted differently from what occurs in the panels of the prior art, whereby the structural strength of the product is improved in comparison with structures having links perpendicular to the skins. Preferably, the tufts 71 are comprised within a finite number of planes parallel to the plane of alignment 306 and spaced apart by a few tenths of millimetres.

The insertion of the individual tufts 71 following more than two different orientations can be envisaged. The insertion of at least one of the individual tufts 71 following a perpendicular orientation in relation to the plane of the skins 2 can be envisaged. Finally it can be envisaged that the tufts 71 are not secant, due for example to their spacing or orientations included within different planes, or conversely, that a tuft 71 be secant to more than one other tuft 71. Assemblies are then obtained respectively called V-shaped or lattice patterned.

A panel can also be envisaged, produced by a manufacturing device according to the invention, by carrying out several needlepunching passes of the panel separated by a pivoting of the panel in its own plane, making it possible to obtain optimized performance of the panel in several directions. The panel obtained by several passes comprises at least:
rammed fibers following at least one first orientation substantially parallel to a first plane of alignment substantially perpendicular to the surface of at least one of the skins, this first plane of alignment being parallel to the travel direction of the panel during a first pass,
rammed fibers following at least one second orientation substantially parallel to a second plane of alignment substantially perpendicular to the surface of this same at least one of the skins, this second plane of alignment being parallel to the travel direction of the panel during a second pass,
   the first plane of alignment and the second plane of alignment being transverse to each other, and being preferably perpendicular in the event that the two needlepunching passes of the panel are separated by a pivoting of the panel through 90 degrees in its own plane. Such a panel has mechanical characteristics that are better distributed in space, as this panel is reinforced along several directions.

In the example shown, the individual tufts 71 are inserted into is the mass of the foam slabs 4 without the need for advance preparation by a recess. The insertion of the individual tufts 71 at pre-arranged intervals in the foam slab 4 can be envisaged.

The impregnation of the fiber batts with the bonding material 22 has the effect of making the bonding material penetrate into the core 3 along the sites occupied by the tufts 71. This penetration is allowed by means of wells 45 (FIG. 3) formed in the core 3 during the ramming of the fibers 7 as will be described below.

The bonding material 74 that floods the rammed fibers 71 has the effect of closely attaching these rammed fibers to the adjacent materials belonging to the core 3, therefore in the example the foam 4. An attachment is thus formed between the core 3 and each skin with the result of a particularly high resistance of the panel to delamination. Moreover, in the case of rammed fibers 7 forming bridges between the two skins, the two skins are also attached to each other. More particularly, in the case shown, in which the fibers of a bridge are fibers taken from one of the skins and rammed through the core 3 until they reach the other skin, the impregnation of resin then produces an attachment between the rammed fibers and said other skin.

In the most usual case of a bonding material, having a better tensile performance than shear performance, the oblique orientation of the rammed fibers 71 relative to the skins has the effect of increasing the stress resistance, in particular resistance to the stresses tending to move one skin in relation to the other.

With reference to FIGS. 4, 5 and 6, a needlepunching apparatus 120 will now be described belonging to a preferred embodiment of the manufacturing device according to the invention intended for the assembly of the core 3 with two skins each comprising a fibrous batt 21 initially devoid of stiffened bonding material. The manufacturing device shown moreover comprises insertion means for inserting the core between the two fibrous skins 21 in a needlepunching path, the core 3 and the batts 21 moving substantially in a travel plane 300 along a travel direction F1.

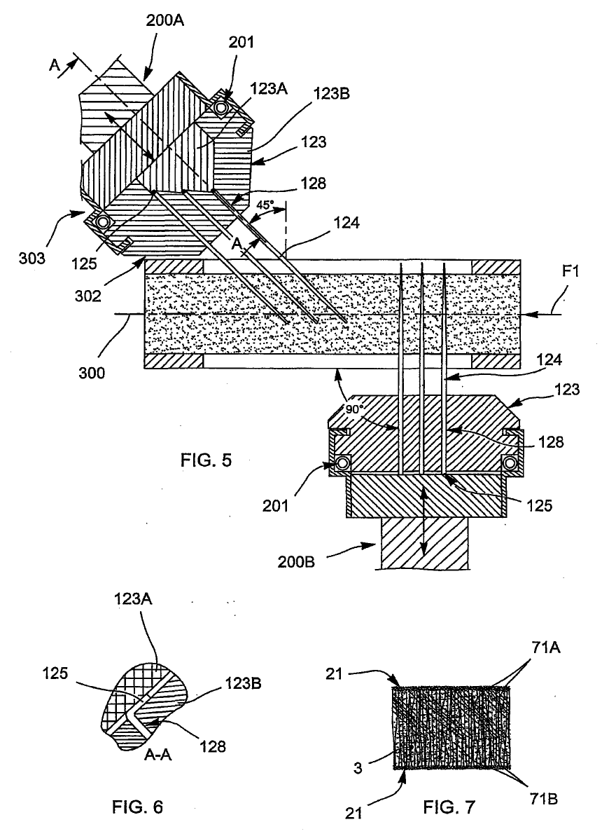

The needlepunching apparatus 120 is constituted by two needlepunching units 200A, 200B situated on each side of the two fiber batts 21 extending in parallel planes and between them defining an inner volume occupied by the core 3. Each of said needlepunching units comprises in particular needles 124 of equal length mounted integrally with a needle board 123. FIG. 6 is an enlargement of part of FIGS. 4 and 5 along the planigraphic plane A-A, detailing the attachment device of the needles. As shown, for the needlepunching unit 200A:
the rear face of the needle board 123A includes openings for the support and positioning of the needle shanks 125,
the front face of the needle board 123B comprises holes 128 passing through the front face of the needle board 123B in which the needles 124 are fitted.
a clamping device 201 acts to bring the two faces of the needle board 123A and 123B towards each other, thus ensuring that the needles 124 are fast with the board 123.

The clamping device 201 shown in FIG. 5 uses a pneumatic technique commonly used in needlepunching machines, and makes it possible to change the rear face of the needlepunching unit 200A in order to adapt this needlepunching unit to different inclinations of strike. The use of other clamping devices can be envisaged, such as for example clamping using bushes, making it possible to obtain an assembly in which the needles 124 are fast with the needle board 123.

The choice of needles 124 of the same length is generally preferred as it allows for less expensive procurement and management for the company. However, needles 124 of unequal lengths can be envisaged, or other arrangements of the needle board 123.

The rear face 123A of the needle board is generally chosen with a surface substantially parallel to the travel plane of the core 3, in such a way that the needle tips are in a plane parallel to the travel plane, as shown for the needlepunching unit 200A.

The needlepunching unit 200B can differ from the needlepunching unit 200A in that it can comprise a needle board without a rear face 123A, in particular in the event that its needles are oriented perpendicularly to the travel plane of the core 3 as shown in FIGS. 4 and 5. Other arrangements of the tips of the needles 124 can also be envisaged, in particular where non-homogeneous mechanical characteristics of the composite panel 1 are required, for example by creating areas in which the penetration of the needles will differ from that carried out in the remainder of the panel.

The orientation of each needlepunching unit 200A, 200B and their needles 124 is adjustable in relation to the skins 21, the orientation of the needles and therefore of the units being capable in particular of being oblique in relation to the skins. For each unit 200A, 200B, the orientation of the needles of the unit is defined by an angle of strike, also called inclination of strike of the unit or of the needles of the unit. The strike angle is defined about an axis substantially parallel to the surface of the skins and to the travel plane 300 and substantially perpendicular to the travel direction F1, this angle of strike being zero for an orientation of the needles parallel to the surface of the skins and the travel plane and pointing in the same direction as the travel direction F1. The strike angle is determined from a chosen adjustment range, in particular for space reasons, comprised between forty-five degrees and one hundred and thirty-five degrees in relation to the surface of the skins. Of course, a wider adjustment range can be considered.

In the example in FIG. 4 the needlepunching unit 200A is oriented at an angle of one hundred and thirty-five degrees in relation to the surface of the skins, and the needlepunching unit 200B is is oriented at an angle of ninety degrees. For each unit 200A, 200B, the needles 124 of the unit are in the retracted position, and their function is to engage with fibers of the batt 21 situated on the side of the core on which the needles in question are located, and to ram these fibers into the core 3 in a penetration movement following the orientation in which the needles 124 are pointing.

The example in FIG. 5 shows the needles 124 when in a state of maximum penetration into the inner volume occupied by the core 3. The tips of the needles of the needlepunching unit 200B situated on one side of the core reach the batt 21 situated on the opposite side of the core. The tips of the needles of the needlepunching unit 200A reach the mid portion of the core 3. Penetrations that are more or less deep than those shown can be envisaged, in particular penetrations reaching or piercing through the opposite batt 21 in order to promote interpenetration of the rammed fibers with the opposite batt.

The needlepunching unit 200A has a bevel 302 along an edge 303 transverse to the travel plane 300 and facing the travel plane. Said bevel 302 is determined so that the needlepunching unit 200A does not come into contact with the batt 21 situated on the same side relative to the core when its needles 124 are in a state of maximum penetration. The needlepunching unit 200B shown in the example in FIGS. 4 and 5 also has a bevel. Particularly in the case of a strike at ninety degrees in relation to the skins, the use of a board without bevels with a larger surface area for insertion of the needles can be envisaged.

The example in FIG. 7 gives a representation of the distribution of the individual tufts 71A, 71B in the core 3 obtained according to the arrangement of the needlepunching units shown in FIGS. 4, 5 and, 6. The rammed fibers have at least two different orientations. Fibers belonging to a first assembly of tufts of fibers 71A rammed by the unit 200A have an oblique orientation in relation to the skins 21, and fibers belonging to a second assembly of fiber tufts 71B rammed by the unit 200B have an orientation substantially perpendicular to the fiber batts 21.

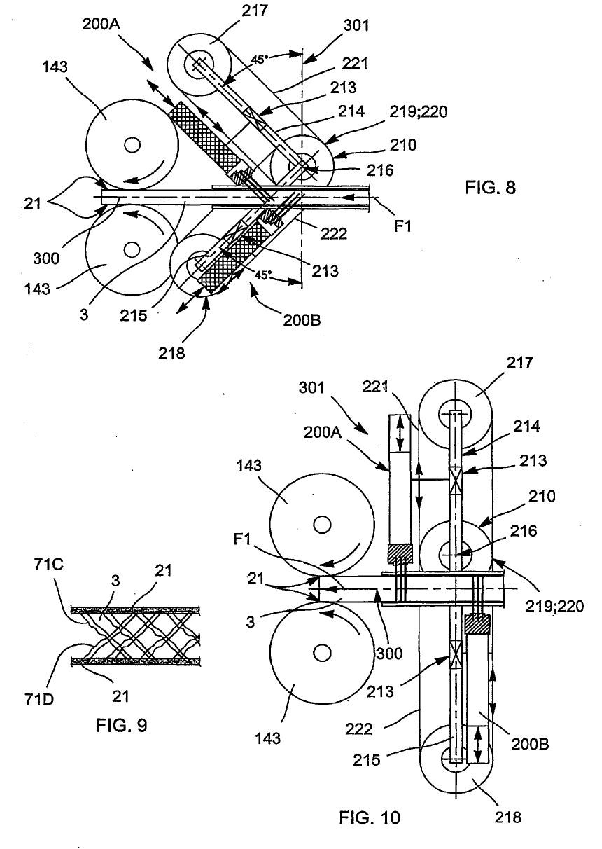

With reference to FIGS. 8, 9, 10 and 11 a control device 210 will now be described belonging to the preferred embodiment of a manufacturing device according to the invention, arranged in order to actuate the needles of each needlepunching unit with an alternate strike movement and at a particular inclination of strike.

In the example in FIG. 8, the two needlepunching units 200A, 200B situated on either side of the core 3 form an angle of one hundred and thirty-five degrees in relation to the skins 21. The two needlepunching units 200A, 200B are each guided in their translational motion by a sliding connection 213 to adjustable parts 214 and 215 respectively. One end of each adjustable part 214, 215 is temporarily pivotable about the axis of the drive shaft 216, in order to allow for adjustment of the orientation (and therefore the inclination of strike) of each of the needlepunching units 200A, 200B. As shown in FIG. 12, the drive shaft 216 is arranged on one side of the travel plane 300, parallel to the travel plane 300 and transverse to the travel direction F1 of the core 3 and skins. The other end of each adjustable part 214 and 215 is equipped with a return pulley 217, 218 respectively. The drive shaft is connected at an adjustable angular position to two similar drive pulleys 219 and 220, which allow for two belts to be driven, 221, 222 respectively. The tension of the belts 221, 222 is maintained by the return pulleys 217, 218 respectively. The needlepunching units 200A, 200B are linked in a rigid manner to the belts 221, 222 respectively, on these portions of said belts which are tensioned during the strike of each needlepunching unit.

The needlepunching unit 200A, situated on the same side as the drive shaft 216 and the loop 221 relative to the travel plane 300 of the product (i.e. of the panel being produced) is situated outside the loop formed by the belt 221. The needlepunching unit 200B, situated on the same side as the loop 222 relative to the travel plane 300, is preferably situated inside the loop 222 formed by the belts that drive it. This is device allows a simultaneous striking of the needlepunching units 200A and 200B without risk of their needles 124 colliding, particularly when the inclination of one of the units is relatively far off by ninety degrees in relation to the skins 21. But it is also possible to place said needlepunching unit 200A inside the loop formed by its drive belts, or the needlepunching unit 200B outside the loop formed by its drive belts.

In a step of adjustment of the control device 210, the inclination of the adjustable parts 214 and 215 around the shaft 216 is adjusted first, then the angular position of the drive pulleys 219, 220 around the shaft 216 is adjusted so that striking is simultaneous despite the phase difference that can be caused by adjustments of the inclination. Alternate striking can be envisaged, in particular in the case of face-to-face striking.

In a preferred solution, the belts 219, 220 will be toothed belts. Other drive solutions can nevertheless be envisaged, for example the use of a single belt, or conversely several belts for each needlepunching unit, and also the use of a chain or a crank mechanism.

The penetration of the two needlepunching units 200A, 200B takes place towards the entry of the batts, i.e. in the opposite direction to the feed movement F1 of the batts. The tensioning of the batts at the moment of needlepunching is provided by the drive cylinders 143, described below, with possible stretching of the batts between the drive cylinders 143 and the needlepunching area.

Penetration of the two needlepunching units 200A, 200B towards the exit of the batts can be envisaged, i.e. in the direction of the feed movement F1 of the batts. In this case it is possible to provide a related control system allowing for the prevention of the risk of de-tensioning the batts.

The example in FIG. 9 is a cross-sectional part-view of the distribution of the individual tufts 71C, 71D in the core 3 obtained according to the arrangement of the needlepunching units shown in is FIG. 8. Some of the fibers belong to a first set of tufts of fibers 71C rammed by the unit 200A, having an oblique orientation in relation to the skins 21, and other fibers belong to a second set of tufts of fibers 71D rammed by the unit 200B, having an oblique orientation in relation to the skins 21 and being inclined in the opposite direction in relation to the fibers of the first set of tufts.

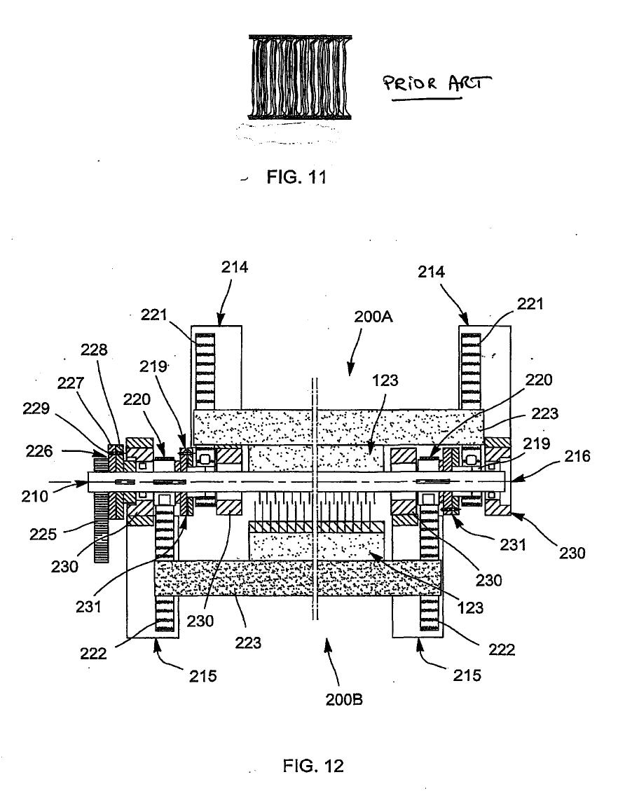

The example in FIG. 10 shows a variation of FIG. 8, in which the two needlepunching units 200A, 200B both form an angle of ninety degrees in relation to the skins 21. The distribution of the fibers obtained is shown in FIG. 11. Within the framework of this particular angular arrangement of the two needlepunching units 200A, 200B a panel according to the prior art is obtained with a fiber distribution comparable to that described in document EP 1 686 210 A1.

FIG. 12 is a cross-sectional side view of the control device 210 along the plane 301 in FIG. 8. As shown in FIG. 12, the needlepunching units 200A, 200B both comprise a needle board 123 rigidly connected to a beam 223. These beams 223 are slidably connected at their ends to the two columns of the adjustable parts 214 and 215. The drive shaft 216 as well as the adjustable parts 214 and 215 are guided for rotation by means of four bearings 230 connected to the frame of the manufacturing device.

In the example in FIG. 12, a lever arm 225 actuates the drive shaft 216 in rotation by means of an adjustment device 226. The adjustment device 226 is constituted by two disks 227, 228 mutually immobilized in the example by a screwing device 229. The use of other immobilisation devices can be envisaged, such as for example the use of pins. The disk 227 is rigidly connected to the lever arm 225, while the disk 228 is rigidly connected to the shaft 216.

The lever arm is itself actuated by the connecting rod small end of a single eccentric drive, not shown.

In the example in FIG. 12, the movement of the drive shaft 216 is transmitted to the needlepunching unit 200A or 200B using is respectively two belts 221 or two belts 222, themselves driven by two drive pulleys 219 or two drive pulleys 220 respectively. The drive pulleys 220 are firmly attached to the shaft 216, such that the adjustment device 226 ensures the adjustment of the penetration of the needlepunching unit 200B, in particular as a function of the inclination of strike of the needlepunching unit 200B.

Two adjustment devices 231, comparable to the adjustment device 226, allow for the angular adjustment of the belts 221 relative to the transmission shaft 216, thus ensuring the adjustment of the penetration of the needlepunching unit 200A. There is therefore interdependence of the adjustment of the two needlepunching units 200A, 200B. It is however possible to envisage the use of different adjustment devices, in particular independent adjustment devices.

It can also be envisaged that if there are more than two needlepunching units, certain needlepunching units can be jointly adjustable.

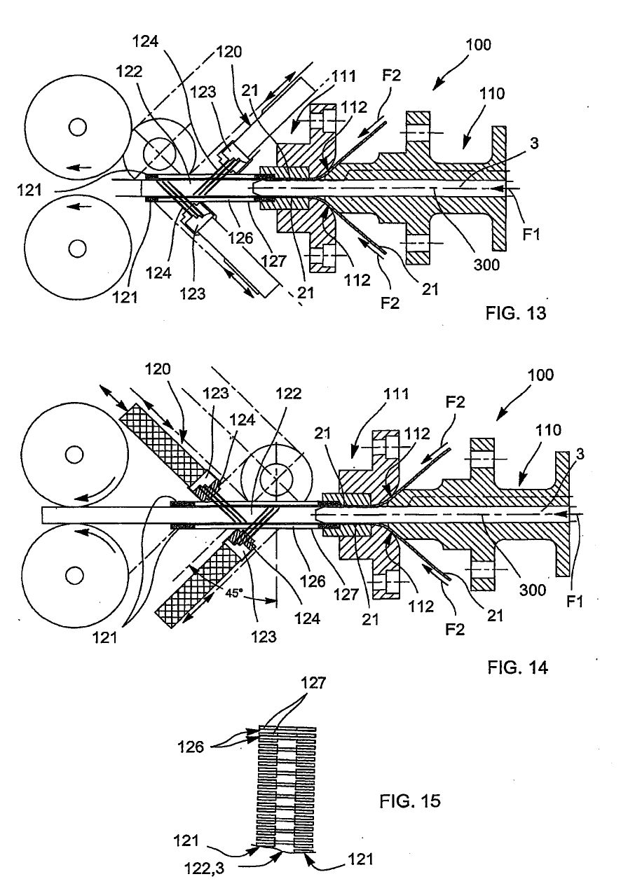

With reference to FIGS. 13, 14 and 15, the insertion means 100 belonging to the preferred embodiment of the manufacturing device according to the invention will now be described. The insertion means 100 comprise a guide 110 for the insertion of the core 3 in a feed movement (arrow F1, previously called travel direction) towards the left in FIG. 13, and a guide 111 positioned downstream of the guide 110 in order to insert the stack comprising the core 3 placed between two fiber batts 21. The guides 110 and 111 between them define two insertion slots 112, lower and upper respectively, for inserting each of the batts 21 on the upper and lower faces respectively of the core 3 at the entrance to the guide 111, along the arrows F2.

The insertion means 100 shown in FIG. 13 are associated with the needlepunching apparatus 120 intended to assemble the core 3 with the two batts 21. The needlepunching apparatus 120 in turn comprises:
two strippers 121, between them defining a needlepunching is path 122 (comprised within the travel plane 300) constituting the continuation of the path through the guide 111;
the two needle boards 123 situated on each side, respectively, of the needlepunching path 122, and each holding needles 124; the tips of the needles 124 are capable of penetrating into the needlepunching path 122 through slots 126 formed between plates 127 constituting the strippers 121 in the area where the needles 124 are located.

In FIG. 13, the needlepunching apparatus 120 is arranged in such a way as to orient the penetration of the needles 124 towards the exit of the batts, i.e. partially in the direction of the feed movement F1 of the batts. This preferred arrangement makes it possible to relieve the stress on the mechanical structure of the panel during production in the downstream direction of the needlepunching apparatus relative to the travel direction, but requires a certain tension of the fibrous materials upstream of the needlepunching apparatus. This solution favours the insertion of powdery intercalary materials into the panel, and appears to reduce the hindrances to access to the elements for the adjustment of the tables and the strippers of the manufacturing device according to the invention.

In FIG. 14, the needlepunching apparatus 120 is arranged in such a way as to orient the penetration of the needles 124 towards the entry of the batts, i.e. partially in the opposite direction to the feed movement F1 of the batts. This arrangement makes it possible to maintain a certain tension on the panel being produced from the drive cylinders 143, but could be unfavourable for the supply of powdery intercalary materials.

Each needle board 123 is fixed to a means of reciprocating actuation in a previously chosen direction, such that the tips of the needles 124 enter the needlepunching path 122 and are retracted therefrom. The feeding of the assembly of the core 3 and the batts 21 along the arrow F1 is synchronized with the movement of the needles 124 such that the assembly advances when the needles 124 are disengaged from the needlepunching path 122 and the feeding of the assembly is stopped when the needles 124 are protruding into the needlepunching path 122. In the example shown, the needles 124 situated on one side of the needlepunching path 122 are offset in relation to the needles 124 situated on the other side, making it possible to synchronize the two needle boards 123 so that all the needles 124 are simultaneously engaged in the needlepunching path 122 and are simultaneously disengaged from it in order to allow for the feeding of the assembly.

The function of the needles 124 is to engage with fibers of the batt 21 situated on the side where the needles in question are located, and to ram these fibers into the core 3 of the assembly. When they are in the state of maximum penetration, as shown in FIG. 13, the tips of the needles reach the opposite batt 21. Thus, in this embodiment, the fibers driven by the needles are rammed until they reach the opposite batt 21. It is even possible to arrange for the needles to pierce through the opposite batt, totally or partially, in order to promote interpenetration of the rammed fibers with the opposite batt.

When the needles 124 reach the opposite batt 21, the needles can also, alternatively or in addition, ensure the ramming of the fibers by pulling of the fibers of the batt 21 opposite to the side on which the needles in question are located. In particular, needles having barbs oriented for pulling fibers will penetrate more easily into the product during needlepunching. This can be particularly favourable taking account of the oblique direction of penetration according to the invention.

Generally, the arrangement of the needles on the boards 123, the strike rate of the needles 124 and the pitch of the product along the arrow F1 are chosen in combination in order to obtain the desired pattern of rammed fibers.

After exit from the needlepunching apparatus 120, the semi-finished product is cut into in panel units, by transverse cutting with a known cutting appliance, not shown. In a moulding station, the cut panels are placed in a mould into which the bonding material such as resin is injected. This step, which is itself standard, is also not shown, as it is known in the production of so-called “sandwich” composite panels. The mould can be flat for producing a flat panel, or conversely not flat in order to simultaneously deform the flat semi-finished product into a finished panel having a desired non-flat form.

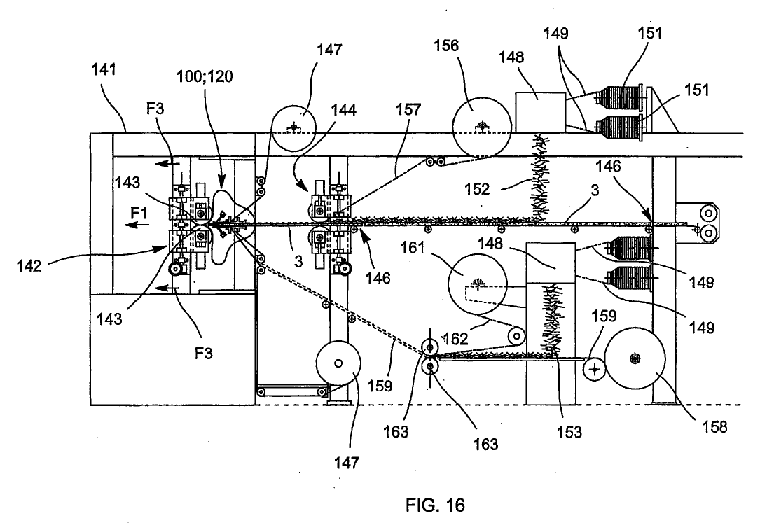

FIG. 16 shows an example of a manufacturing device according to the invention.

The insertion means 100 and the needlepunching apparatus 120 will not be described again, as they can be identical to those in FIG. 13. On exit from the apparatus 120, the semi-finished product passes between the drive cylinders 143 of a step by step feed apparatus 142, driven by servo-motors. The periphery of the cylinders 143 comprises a lining of known type in order to provide a positive connection with the semi-finished product leaving the needlepunching. A further feed apparatus 144 of the same type is placed upstream of the insertion means 100 in order to drive the materials step by step before their entry into the guide 110 (see FIG. 13). In the situation at the start of production shown in FIG. 16, where the front edge of the semi-finished product has not yet reached the downstream feed apparatus 142, drive is provided by the upstream apparatus 144. Then, the two apparatus 142 and 144 operate in a synchronized manner in order to feed the product when, as already disclosed with reference to FIG. 13, the needles 124 are disengaged from the product. Moreover, in the example shown in FIG. 16, the materials constituting the core 3 of the product are pre-cut transversally at locations 146 corresponding to the future transverse edges of the panels to be made. Thus the subsequent cutting of the panels after needlepunching and before moulding is facilitated. In order to be sure that the subsequent cutting coincides with the previously cut locations 146, the latter have a slight spacing. Due to the presence of the two feed apparatus 142, 144, each pre-cut segment of the core 3 is positively driven by one and/or the other of the two feed apparatus such that the spacing of the pre-cuts 146 is maintained until the later cutting site (not shown) is reached. Arrows F3 symbolize that one of the feed apparatus (142) can be adjusted with respect to its position parallel to the feed direction F1 of the product, in particular in order to ensure that the distance between the two feed apparatus 142, 144 is less than the length between successive pre-cuts 146.

The frame 141 of the manufacturing device shown in FIG. 16 is capable of supporting on each side of the travel plane of the core 3, a reel of pre-strengthened mat 147 so that this mat constitutes a fiber batt 21 arriving through the slots 112 along the arrows F2 (see FIG. 13). This mode of operation of the device requires the ability to make or to obtain the pre-strengthened mat. It also requires a handling of the reels 147, the consumption of which can be relatively quick, given that the method according to the invention is capable of a very high hourly production rate. Moreover, modifying production in progress in relation to the composition and/or the width of the fibrous reinforcement of the skins requires having available other reels 147 of a mat having the desired structure, dimensions and/or composition. It is apparent in particular that setting up for a specific production can be relatively laborious with the mats 147.

For this reason in particular, the device shown in FIG. 16 moreover comprises on each side of the travel plane of the core 3, upstream of the means 100 and of the appliance 120, a cutting apparatus 148 that transforms filaments 149 originating from reels 151 into cut fibers 152 scattered on the upper face of the core 3 upstream of the upstream feed apparatus 144, and respectively into cut fibers 153 intended to be inserted in scattered form on the lower side of the core 3 through the lower insertion slot 112 (FIG. 13). The filaments 149 are typically inorganic filaments (known as “roving”). The fibers 152, 153 have a length preferably greater than 3 to 4 times the thickness of the core 3. Thus, in a typical application, the length of the fibers is 50 to 100 mm.

The force of gravity is used to deposit the fibers 152 directly onto the upper face of the core 3. The frame 141 moreover supports, above the core 3, a reel 156 of a material in the form of a strip 157 having substantially the same width as the core 3, which will be positioned above the deposited fibers 152, in particular for producing a pre-fixing of the fibers 152 onto the core 3. The strip material 157 is inserted with the previously deposited fibers 152, between the drive cylinders of the upstream feed apparatus 144, so that the cylinders of the apparatus 144 pack the fibers 152 between the core 3 and the strip material 157. The assembly enters the means 100 through the guide 110 (FIG. 13). In this mode of operation, as a result, the guide 110 acts to insert not only the core 3 but also the fibrous reinforcement of the upper skin of the future panel.

Below the travel plane of the core 3, the frame 141 supports a further reel 158 for a strip material 159 that can be identical to the strip material 157 but the path of travel of which is such that it receives the cut fibers 153 falling from the lower cutting apparatus 148. Then, the strip material 159 is guided towards the lower insertion slot 112 (see FIG. 13). The frame 141 supports a further reel 161 for a third strip material 162 that will be placed above the cut fibers 153 deposited on the strip material 159. The fibers 153 are sandwiched and packed between the strip materials 159 and 162 when the assembly passes between two guide and nip rolls 163. The assembly then enters the means 100 through the lower slot 112.

The two strip materials 157 and 159 forming the two outside faces of the product before coating can typically be a light consolidated web, for example from 15 to 30 g/m². The consolidated web is for is example constituted by thermowelded fibers, for example made from polypropylene, but it can also be a web formed of filaments (“spun”), or also a fabric, a non-woven material, a scrim, made of inorganic, organic, plant, etc., fibers intended to have a function of strengthening the skins, and/or other specific desired functions. The strip material 162 to be placed between the lower fibers 153 and the lower face of the core 3 can either be of a type similar to one of those described for the materials 157 and 159, or, for example, a much heavier material, from 150 to 300 g/m² for example, having an advantageous function of maintaining a certain bulk up to the moulding stage in order to drain the impregnation resin. Such a bulky non-woven material can be constituted by polypropylene fibers. Draining fabrics also exist having substantially the same properties, that can also be used.

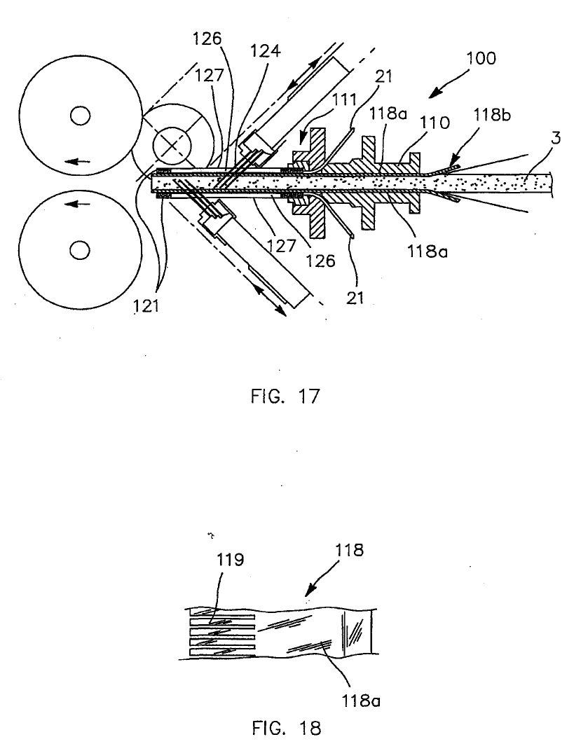

In the example shown in FIGS. 17 and 18, the manufacturing device, which will be described only in relation to its differences in relation to the one in FIG. 13, comprises combs 118 between which is formed the passage for the core 3 in the guide 110. The combs 118 comprise, inside the guide 110 and 111, a continuous wall 118a. Upstream of the guide 110, the combs 118 form a convergent 118b with each other that acts to guide the material in the passage of the guide 110. The combs 118 are extended by teeth 119 coinciding with the plates 127 of the strippers 121. The spaces between the teeth 119 coincide with the slots 126 between plates. The fibrous reinforcements 21 pass between comb and stripper. The needles 124 pass into the slots 126 between plates 127, pass through the fibrous reinforcements 21, then pass between the teeth 119 of the combs 118 in order to ram into the core 3. The function of the combs 118 is to support the fibrous structures 21 during the needlepunching in order to prevent the needlepunching stresses from compressing the core 3, in particular when the latter is made from a relatively light foam. At their downstream ends, the teeth 119 are separated from each other and thus form apertures through which the fibers rammed by the is needlepunching can leave the comb during the downstream movement of the product.

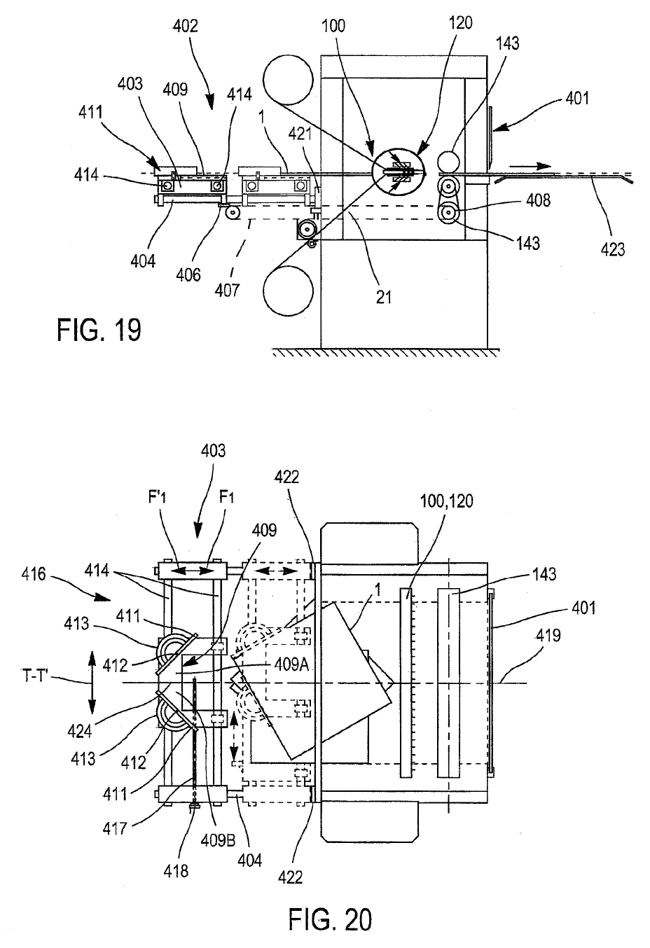

In the embodiment of FIGS. 19 and 20, the machine comprises:
a needle punching apparatus 120 preceded by insertion means 100 which are all, e.g., substantially as described in reference to FIGS. 13, 14, 15 and followed by panel-extraction cylinders 143, and further downstream by a panel-cutting means 401.
a panel input means 402 arranged upstream of the insertion means 100 and the needle punching apparatus 120.

The panel input means 402 includes a carriage 403 movable in the travel direction F1 and in the opposite direction F′1. To this end, the carriage is slidably mounted on side rails 404 which are, in operation, rigidly connected to the machine frame.

The movement of the carriage 403 comprises two ranges, i.e. a rear range comprising the position shown in continuous lines in FIGS. 19 and 20, along which the carriage is freely movable along F1-F1′ and adapted to be displaced manually, and a front range (dotted lines) in which a clutch member 406 of the carriage 403 engages a timing belt 407 which is driven at the same linear speed as the surface of the panel extraction cylinders 143.

To this end, the belt engages a pulley 408 which is fast with one of the cylinders 403. When the carriage 403 is pushed by hand from its rear range up to the beginning of its front range, the clutch member 406 engages the timing belt 407 automatically.

The carriage 403 has an upper supporting table 409 for the rear portion of a panel 1. Two edge guides 411 provided above the table 409 are pivoted to the table 403 about a respective vertical axis 412. Each guide 411 is provided with an adjustment means 413 allowing to select an orientation of the guides 411 about their respective axis 412, and to secure the guides in their selected position. They are normally adjusted to be orthogonal to each other, as shown in FIG. 20, to define the position of two adjacent edges of a rectangular panel resting on table 409. As will be described later, a parallel position is also possible in an improved embodiment.

The position of the table 409 along the transverse direction T-T′ is adjustable with respect to a carriage frame 416. In this embodiment, the table is slidably mounted on two transverse slides 414 belonging to the frame 416 of the carriage 403. A screw drive 417 provided with a hand-wheel 418 allows adjustment of the transverse position of the table, in particular with respect to the centre axis 419 and with respect to the needles of the needle punching apparatus 120.

The rails 404 are adjustable in height by means of a height adjustment device 421 so that the plane of the table 409 can correspond with the supporting plane of the panel in the needle punching apparatus 120.

Operation is as follows:
The operator inserts the front portion of a panel into the entry of the insertion means 100 and needle punching apparatus 120 after having adjusted the guides 411 to define the desired orientation of the panel 1 in the horizontal plane. In FIG. 20, three panel orientations are schematically shown. The operator has also adjusted beforehand the transverse position of the table so that the panel has a desired position with respect to the center axis 419. The desired position is determined in view of the tuft patterns to be obtained. Typically, the panel 1 already has tufts along at least one direction of alignment. If it already has tufts along at least two directions, then the pattern will vary depending upon the transverse position of the panel, which will change the position of the tuft rows along the third direction with respect to the intersections of the rows of the two first directions.

The insertion means 100 and the cutting mechanism 401 are deactivated because panel 1 already has skins, and is already cut at length. If the machine is only intended for use in providing the second, third etc alignment planes of tufts, the machine could have no insertion is means 100 and no cutting mechanism 401.

Once the panel is pre-inserted in the needle punching apparatus 120, the operator pushes the carriage 403 along rails 404 until clutch member engages timing belt 407 which further displaces the carriage 403. At a stage the guides 411 engage panel 1 and orient it accordingly so that two adjacent edges of the panel are applied flat against the edge guides 411. Carriage 403 pushes the panel 1 through the needle punching apparatus 120.

At a moment, panel 1 is caught by the panel-extracting cylinders 143 defining the same feeding speed as the timing belt 407. At a later stage, the carriage 403 reaches an abutment 422 which actuates a retracting means (not shown) for the clutch member 406 which is, as a result, disengaged from the timing belt 407. The operator draws back the carriage 403 manually. Meanwhile, the panel 1 completes its travel through the needle punching apparatus 120 due to being driven by the panel extractor cylinders 143. The panel thereafter reaches an output table 423 from where it can be stacked or returned to the machine input for a further pass under a different orientation, or the same orientation with different needles, e.g. different needle inclination.

In an improved embodiment specifically useful in the case represented where the machine is also able to produce continuous panel with longitudinal rows of tufts, the table can be separated into two parts along a separation line 424, each part 409A, 409B having one of the guides 411. Each part 409A, 409B is separately guided along the guides 414. For continuous production, the two parts are spaced apart from each other along the guides, and the guides 411 are oriented parallel to each other to guide the foam slab (panel core 3) between them. The part 409A which is not driven by the screw drive 417 is, after separation, freely slidable on the guides and can be secured in place by additional means, not shown, once in correct place.

FIG. 21 illustrates the tufts obtained along three alignment planes which are at 60° of each other to form a triangular pattern of rows which is also illustrated in FIG. 22. Each intersection site is intersected by the three kinds of rows.

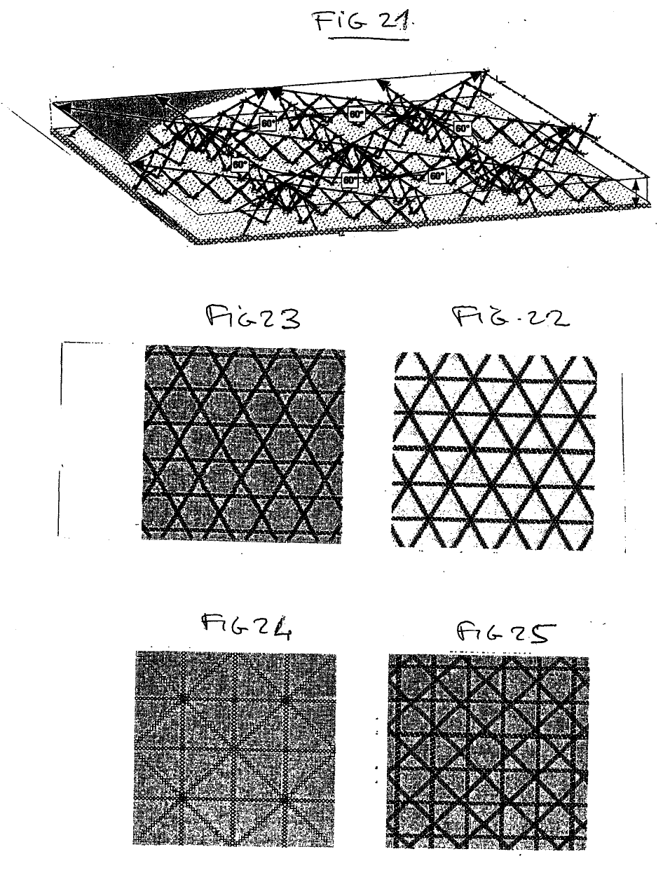

The embodiment of FIG. 23 is similar to that of FIGS. 21 and 22 except that the rows intersect only two by two, thereby to create an hexagonal pattern.

In the embodiments of FIGS. 24 and 25, there are four planes of alignment, i.e. a longitudinal plane which has been obtained during the initial production of the continuous product, before cutting, and the three others have been obtained with the carriage 403 as described herein above. In this case, one of the orientations of the carriage is with one guide 411 parallel to transverse, and the other parallel to longitudinal, to form the row which is perpendicular to the initial (longitudinal) row.

In FIG. 24 the oblique rows only intersect at intersection sites where the longitudinal and transverse rows also intersect. This requires two different needle boards and stripper plates in the needlepunching apparatus because the oblique rows are more spaced to each other than the longitudinal and transverse rows.

In the embodiment of FIG. 25 the spacing between the rows is the same in all the four directions with the result that the pattern is not everywhere the same. This can be produced with one kind of needle boards and stripper plates.

Of course, the invention is not limited to the examples described and shown.

If fibers are used that are capable of thermo-fusion naturally, or as a result of prior coating, it is possible to produce a panel without the need for impregnation by injection of resin in a mould, simply by placing the semi-finished product in a mould that is brought to a sufficient temperature to allow for the thermo-fusion effect to take place on all or part of the fibers.

The core 3 can itself be at least partially fibrous.

It is also possible to produce a panel having two faces profiled so that they are not flat.

The dimensions of a panel according to the invention can be very freely chosen depending on the fields of application which can be: motor vehicle interior trim, bodywork panels for utility vehicles, bodywork parts or chassis platforms for motor vehicles, panels for construction, for furniture, insulating panels, roofing panels, panels for the interior trim of railway vehicles, aeroplanes or boats, door leaves, etc. Non-limitatively, thicknesses from 10 mm to 150 mm can be produced. The plastic materials used can be chosen from thermoplastic or thermosetting materials. The width of the panels, relative to the direction F1, can in principle range from 1.5 metres, up to as much as 10 m.

In all the examples shown, the components of the core 3 have a stable form on entry to the manufacturing device.

However, the different guide and support systems described and shown, in particular the combs 118, make it possible to envisage the use of a core 3 having a certain pliability or flexibility, which then allows for moulding with a complex shape or significant deformation, for example for producing motor vehicle parts or elements having a similarly complex shape.

It is also possible, according to document EP 0 594 700 B1, to provide for the use of mechanical holding devices during needlepunching operations, in particular along longitudinal bonding lines, making it possible if desired to insert an intercalary component in the longitudinal spaces made by mechanical action between the longitudinal bonding lines already produced. During needlepunching steps, these mechanical holding devices act to hold the skins apart, and act as an anvil during the needlepunching of the tufts of fibers connecting the skins.

At the entry to the manufacturing device there can be means for is processing at least one component of the core 3 and/or at least one of the skins.

The machine of FIGS. 19 and 20 can be automated in part or totally. For example, a control unit can be provided, allowing the user to select the orientations of the tuft rows, e.g. 0°, 60° and 120°. Then, different patterns are proposed on a screen, and the operator selects the desired pattern. Upon these instructions, the machine automatically adjusts the guides 411, and the transverse position of the table 409 for the production of each group of rows, corresponding to each alignment plane.

It can be considered that in at least one alignment plane the fibers have only one orientation. While a particular embodiment of the present panel and associated method has been described herein, it will be appreciated by those skilled in the art that changes and modifications may be made thereto without departing from the invention in its broader aspects and as set forth in the following claims.

1. A composite panel, comprising two fibrous skins, and a core placed in an inner volume between the skins and linked to the skins by a solidified bonding material, in which linking fibers originating from at least one of the skins have been rammed into the inner volume between the skins, wherein at least part of the rammed fibers have at least one oblique orientation in relation to at least one of the skins.

2. A panel according to claim 1, wherein the rammed fibers have at least two different orientations.

3. A panel according to claim 2, wherein the two orientations comprise an orientation substantially perpendicular to at least one of the skins.

4. A panel according to claim 2, wherein the two orientations are inclined in opposite directions to each other in relation to the skins.

5. A panel according to claim 2, wherein rammed fibers following a first orientation are substantially parallel to a first plane of orientation, rammed fibers following a second orientation are substantially parallel to a second plane of orientation, the first plane of orientation and the second plane of orientation being transverse to each other, the fibers along the first orientation and the fibers along the second orientation all being substantially parallel to a plane of alignment transverse to the planes of orientation.

6. A panel according to claim 2, wherein the rammed fibers are grouped into tufts situated at sites where bonding material is also present, tufts of rammed fibers having a first orientation each being secant or tangent to a tuft of rammed fibers having a second orientation.

7. A composite panel according to claim 1, wherein the fibers are arranged on at least two planes of alignment which are perpendicular to at least one of the skins and at an angle of each other.

8. A composite panel according to claim 7, wherein the fibers have at least two different orientations in each plane of alignment.

9. A device for making a panel according to claim 1, comprising:
insertion means for inserting a core between two fibrous skins in a needlepunching path along a travel direction,
at least one needlepunching unit comprising needles and arranged in order to ram fibers of at least one of the skins into a volume situated between the skins, the at least one needlepunching unit comprising means of actuating its needles obliquely according to an inclination of strike in relation to a travel plane of the core and the skins.

10. A device according to claim 9, wherein the at least one needlepunching unit comprises means of adjusting the inclination of strike along which its needles are actuated, in relation to said travel is plane.

11. A device according to claim 9, wherein it comprises two needlepunching units arranged on each side of the travel plane.

12. A device according to claim 11, wherein the two units are adjustable independently of each other in respect of the inclination of strike.

13. A device according to claim 12, wherein the two units are controlled from a single shaft, the device comprising means of adjusting a setting of the strike cycles of the two units in relation to each other, in particular as a function of their respective inclination of strike.

14. A device according to claim 9, wherein the tips of the needles of the at least one needlepunching unit are in a plane substantially parallel to the travel plane.

15. A device according to claim 14, wherein the needles are of equal length and have a shank resting against a rear face of a needle board, such rear face being generally substantially parallel to the travel plane.

16. A device according to claim 15, wherein the rear face of the needle board comprises openings for the support and positioning of the shanks of the needles.

17. A device according to claim 9, wherein the at least one needlepunching unit has a bevel along an edge transverse to the travel plane and facing the travel plane.

18. A device according to claim 9, wherein the activation means comprise at least one belt passing around a pulley held by a shaft arranged transversally in relation to the travel direction of the core and the skins, the at least one needlepunching unit comprising at least one mobile element, holding the needles, fixed to one side of the belt, and in that the inclination of strike is adjustable by pivoting of the needlepunching unit around the axis of the shaft.

19. A device according to claim 18, wherein the activation means is comprise a second belt passing around a second pulley held by the same shaft and coupled to a mobile element of a second needlepunching unit acting on the other side of the travel plane.

20. A device according to claim 19, wherein the shaft is situated on one side of the travel plane, the mobile element situated on the same side of the plane as the shaft is essentially situated outside the loop formed by the corresponding belt, and the other mobile element is essentially situated inside the loop formed by the corresponding belt.

21. A device according to claim 9, comprising means for successively defining two different panel orientations in the travel plane, thereby to ram fibers along two different alignment planes.

22. A device according to claim 21, comprising means to position the panel in the desired orientation, to push the panel in the desired orientation through the needle punching apparatus, and to extract the panel from downstream of the needle punching apparatus.

23. A device according to claim 21, wherein the means for successively defining can be spaced apart to form side guides for a continuous panel core.

24. A method for producing a composite panel according to claim 1, wherein by needlepunching, tufts of fibers of at least one of the skins are obliquely rammed into the inner volume in which the core is situated.

25. A method according to claim 24, wherein tufts of fibers are rammed along at least two different orientations, in particular by carrying out two needlepunching passes separated by a pivoting of the panel in its own plane, fibers rammed following a first orientation being substantially parallel to a first plane of alignment substantially perpendicular to the surface of at least one of the skins, rammed fibers following a second orientation being substantially parallel to a second plane of alignment substantially perpendicular to the surface of this same at least one of the skins, the first plane of alignment and the second plane of alignment being transverse to each other.
